(19) United States
(12) Patent Application Publication
(10) Pub. No.: US 2010/0313360 A1
(43) Pub. Date: Dec. 16, 2010

(54) Fabric Treatment Composition and Process for Preparation Thereof

(76) Inventors: Rob Menting, Vlaardingen (NL); Vidyadhar Sudhir Ranade, Utrecht (NL)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/225,281

(22) PCT Filed: Feb. 13, 2007
(86) PCT No.: PCT/EP2007/001296

§ 371 Date: Sep. 17, 2008

(30) Foreign Application Priority Data
Mar. 18, 2006 (GB) 0605512.3

(51) Int. Cl. C11D 17/08; C11D 3/37; D06L 1/20

(52) U.S. Cl. 8/137; 510/356; 510/295; 510/350; 510/355; 510/340

(57) ABSTRACT

The present invention provides a process for the preparation of a non-aqueous liquid fabric treatment composition wherein the process comprises a) provision of a pre-mix comprising cationic cellulosic polymer, water and optional solvent; b) admixture of the pre-mix with at least one anionic surfactant; and, c) subsequent addition of non-ionic surfactant, wherein the steps a) to c) are performed sequentially. The invention further relates to a process to produce a unit dose fabric treatment product, a product produced according to said process, the use of said product as a fabric softener, and a method of fabric treatment.

### FIELD OF THE INVENTION

The present invention relates to a process to form a fabric treatment product which exhibits improved stability. In particular, the invention relates to the production of a fabric treatment product that contains a substantially non-aqueous, comprising less than 20% by weight of water liquid composition, especially a unit dose product.

### BACKGROUND OF THE INVENTION

Product formats for fabric cleaning compositions have traditionally included liquids (viscous or thin), solids, such as powders, granules, small capsules or tablets. Recently, so called unit dose products are experiencing increasing success with consumers, because they eliminate the need for manipulating, and possibly spilling, liquids or powders and simplify the use of a correct dose of the cleaning product for the required purpose. An example of this product format is the liquid unit dose capsule.

Liquid unit dose capsules offer the consumer a convenient way to use pre-measured detergent for laundering purposes, for example, by way of a water soluble package containing a so-called non-aqueous liquid detergent composition, the water soluble package dissolving in the wash to release the detergent composition inside. Such products provide a controllable measured dosing format. It prevents over-dosage and as such has environmental benefits.

Consumers are also interested in having multi-purpose products, for example, detergent compositions that not only clean fabrics but that also have an additional benefit. An example of this is a detergent composition which also conditions the fabrics.

### PRIOR ART

A number of technologies that offer such a benefit are known, such as the use of clays, silicones or cationic polymers. WO-A-2004/056958 (P&G) discloses a cationic silicone or a cationic modified guar gum in a low aqueous composition to provide cleaning and softening. A disadvantage of these compositions is that guar gum derivatives are difficult to incorporate into non-aqueous formulations that are rich in surfactants. When non-aqueous product formats are formulated with high levels of cationic polymers, the products prove unstable and separate on standing. This is undesirable in view of the difficulties involved in the process of filling sachets with an unstable composition, and also because the phase separation inside the sachet after preparation will lead to a product that is unsightly to the consumer. Separation of the phases of the unit dose product leads to uneven dosing in the wash and hence an inefficient product which is undesirable to the consumer.

WO-A-2004/056958 also discloses the processes used to make such non-aqueous compositions, whereby a fabric cleaning system is prepared first by combining all fabric cleaning ingredients, with a fabric softening composition prepared separately and thereinafter combined with the fabric cleaning system to form the final product.

A similar process for formulation is outlined in a brochure on a series of conditioning cationic polymers marketed by Amerchol, a subsidiary of The Dow Chemical Company. This brochure discloses formulating with cationic polymers and advises formation of a pre-mix solution of cationic polymer in water followed by addition of this pre-mix to the surfactant.

Our co-pending application WO-A-2004/069979 discloses laundry compositions containing cationic charged polymers that besides cleaning also give softening during the wash. Preferred polymers are those which arise from natural sources, such as cellulose.

The two-part processes disclosed by the prior art are suitable for stable aqueous liquid detergent formulations.

There still remains a need for stable non-aqueous unit dose compositions offering fabric cleaning in addition to other fabric benefits such as fabric conditioning, and processes for making them. There further remains a need for the production of non-aqueous unit dose compositions that are not highly viscous, so that the final formulated products are filled more easily.

Accordingly an object of the invention is to provide a process for the production of a unit dose fabric treatment product comprising a non-aqueous liquid fabric treatment composition wherein the fabric treatment composition shows favourable characteristics, including improved stability, while offering the consumer one or more fabric treatment benefits in addition to fabric cleaning.

We have now found that this can be achieved by way of the process leading to the product of the present invention. In particular, it has been found that stable, low viscosity liquid formulations having improved stability and suitable for use in a unit dose product format can be produced by a process comprising certain sequential steps, pertaining to the order of addition of the ingredients of the formulation.

Definition of the Invention

A first aspect of the invention provides a process for the preparation of a non-aqueous liquid fabric treatment composition comprising no more than 20% by weight of water, characterised in that the process comprises:
a) provision of a pre-mix comprising cationic cellulosic polymer, water and optional solvent;
b) admixture of the pre-mix with at least one anionic surfactant; and
c) subsequent addition of non-ionic surfactant; wherein the steps a) to c) are performed sequentially.

A second aspect of the present invention provides a process for the preparation of a unit dose fabric treatment product comprising a non-aqueous liquid fabric treatment composition comprising no more than 20% by weight of water, characterised in that the process comprises:
a) provision of a pre-mix comprising cationic cellulosic polymer, water and optional solvent;
b) admixture of the pre-mix with at least one anionic surfactant; and
c) subsequent addition of non-ionic surfactant,

wherein the steps a) to c) are performed sequentially, and wherein the process further comprises encapsulation of the non aqueous fabric treatment composition into a unit dose package.

A third aspect of the present invention provides a unit liquid dose fabric treatment product comprising a non-aqueous liquid fabric treatment composition obtainable by the process according to the present invention.

A fourth aspect of the present invention provides a method of fabric treatment comprising the steps of:
a) providing a unit dose fabric treatment product comprising a non-aqueous liquid fabric treatment composition made according to the process of the present invention; and,
b) contacting one or more articles with the composition at one or more points during a laundering process.

The invention further provides the use of the unit dose product of the third aspect as a fabric softener.

### DETAILED DESCRIPTION OF THE INVENTION

The present invention is directed towards a process for the preparation of a non-aqueous liquid fabric treatment composition comprising no more than 20% by weight of water, characterised in that the process comprises:
a) provision of a pre-mix comprising cationic cellulosic polymer, water and optional solvent;
b) admixture of the pre-mix with at least one anionic surfactant; and
c) subsequent addition of non-ionic surfactant;

wherein the steps a) to c) are performed sequentially.

By the term sequentially, we mean the process steps a) to c) are performed in the order a), b), and then c). This does not exclude additional process steps from being incorporated in between the aforementioned process steps. According to the invention, it is also possible to incorporate other process steps, or additional ingredients, for example incorporation of additional solvent in between steps a) and b) or b) and c), as long as the steps a) to c) are performed in that required order.

The Non-Aqueous Liquid

By “non-aqueous”, or “so-called non-aqueous”, it is meant that the amount of water present in the liquid composition is below the level at which the package would dissolve through contact with its contents. The liquid fabric treatment composition comprises no more than 20%, preferably no more that 15%, still more preferably no more than 10%, by weight of total product of water.

The viscosity of the liquid composition is suitably at least 25 mPaS but no more than 10,000 mPaS. Viscosity is measured on a Bohlin rheometer with cone-plate 4°/40 geometry at 25° C. at a shear rate of 21 s⁻¹.

The Cationic Cellulosic Polymer

The term “cationic cellulosic polymer” refers to polymers having a cellulosic backbone and an overall positive charge. Cellulose is a polysaccharide with glucose as its monomer, specifically it is a straight chain polymer of D-glucopyranose units linked via β-1,4 glycosidic bonds and is a linear, non-branched polymer. The cationic cellulosic polymers present in the compositions of the invention have a modified cellulosic backbone, modified in that additional chemical groups have been reacted with some of the free hydroxyl groups of the cellulosic backbone to give an overall positive charge to the modified cellulosic monomer unit.

A preferred class of cationic cellulosic polymers suitable for this invention are those that have a cellulosic backbone modified to incorporate a quaternary ammonium salt. Preferably the quaternary ammonium salt is linked to the cellulosic backbone by a hydroxyethyl or hydroxypropyl group. Preferably the charged nitrogen of the quaternary ammonium salt has one or more alkyl group substituents.

Typical examples of preferred cationic cellulosic polymers include cocodimethylammonium hydroxypropyl oxyethyl cellulose, lauryldimethylammonium hydroxypropyl oxyethyl cellulose, stearyldimethylammonium hydroxypropyl oxyethyl cellulose, and stearyldimethylammonium hydroxyethyl cellulose; cellulose 2-hydroxyethyl 2-hydroxy 3-(trimethyl ammonio) propyl ether salt, polyquaternium-4, polyquaternium-10, polyquaternium-24 and polyquaternium-67 or mixtures thereof.

More preferably the cationic cellulosic polymer is polyquaternium-10. Suitable commercial cationic cellulosic polymer products for use according to the present invention are marketed by the Amerchol Corporation, a subsidiary of The Dow Chemical Company, under the trade name UCARE Polymer LR-400.

The term cationic cellulosic polymer can include a single polymer or a mixture of different polymers.

Any suitable counterion may be used with the cationic cellulosic polymer. Preferred counterions for the cationic cellulosic polymer include: the halides (chloride, bromide, and iodide), hydroxide, phosphate, sulphate, hydrosulphate, ethyl sulphate, methyl sulphate, formate, and acetate.

Many of the aforementioned cationic polymers can be synthesised in, and are commercially available in, a number of different molecular weights. In order to achieve optimal cleaning and softening performance from the product, it is desirable that the cationic cellulosic polymer used in this invention be of an appropriate molecular weight. Without wishing to be bound by theory, it is believed that polymers that are too high in mass can entrap soils and prevent them from being removed. The use of cationic polymers with an average molecular weight of less than about 850,000 Daltons, and especially those with an average molecular weight of less than 500,000 Daltons can help to minimise this effect without significantly reducing the softening performance of properly formulated products. On the other hand, polymers with a molecular weight of about 10,000 Daltons or less are believed to be too small to give an effective softening benefit.

Provision of the Cationic Cellulosic Polymer Pre-Mix

According to the invention, the pre-mix is provided which comprises cationic cellulosic polymer, water and optional solvent. Preferably the pre-mix comprises cationic cellulosic polymer, water and one or more additional solvents. The cationic cellulosic polymer should be present in the resulting pre-mix in a dissolved state. By a dissolved state is herein defined as the chosen polymer being soluble to the extent of at least 90% by weight of the polymer in the chosen water or water/solvent mix at 25° C. The solvent for dissolution of the cationic cellulosic polymer can be water alone, or water in combination with one or more other solvents as long as the combination will dissolve the polymer and that the water level of the final formulated detergent composition is low enough to not interfere with the integrity of the water soluble packaging. Additional water or other solvent(s) can be added at any time during the process, as long as the total amount of water is in accord with the term “non-aqueous” as defined herein. The total amount of solvent in the liquid fabric detergent can be added as one portion to form the pre-mix, or split up into numerous portions to be added during the process. For the provision of the polymer pre-mix the cationic cellulosic polymer can be added as a solid. An example of this is addition of polymer in powder form or granule form. Alternatively to facilitate dosing of the polymer in a large-scale process, the polymer can be added as a dispersion in a non-solvent (in which the polymer is not soluble). This can be thought of as an addition of a slurry of the cationic cellulosic polymer.

Solvent

In addition to water, the non-aqueous liquid fabric treatment compositions of the invention comprise one or more additional solvents. As stated earlier, the cationic cellulosic polymer pre-mix comprises the polymer, water and optional solvent. Preferably the pre-mix comprises polymer, water and solvent as this facilitates having a higher amount of the polymer present in the pre-mix. Depending on the level of polymer required in the composition, it is possible to dissolve an amount of cationic cellulosic polymer in water alone, with or without the aid of heating, and then further on in the process to add suitable solvent to bring the total amount of water in the composition down to a level which can be classed as non-aqueous as hereinbefore mentioned. Such suitable solvents are miscible with water. Suitable solvents include alcohols, ethers, polyethers, polyols, alkylamines, alkanol amines and fatty amines, alkyl (or fatty) amides and mono-and di-N-alkyl substituted derivatives thereof, alkyl (or fatty) carboxylic acid lower alkyl esters, ketones, aldehydes, glycerides, and non-ionic surfactants such as alkoxylated alcohols or mixtures thereof. Preferred solvents are selected from the group consisting of pentanediols, butanediols, propanediols, such as 1,3-propane diol, alkanol amines, di-alkyl ethers, polyethylene glycols, alkyl ketones (such as acetone) and glyceryl trialkylcarboxylates (such as glyceryl tri-acetate), glycerol, and sorbitol or mixtures thereof. Even more preferred solvents are butanediols, propanediols or a mixture thereof. The most preferred solvent for use in the composition of the present invention is monopropylene glycol (MPG).

Preferably, the solvent is present in the liquid composition in an amount of at least 10% by weight, more preferably from 15% to 50% by weight.

Water Activity of Pre-Mix

The term ‘water activity’ describes the equilibrium amount of water available for hydration of materials at a certain temperature. Numerous devices can measure this parameter directly, while some devices measure a parameter called equilibrium relative humidity (% ERH). The water activity (usually given the parameter A_{w}) is related to equilibrium relative humidity (% ERH) by the equation

% ERH=100×A_{w}

A value for water activity of 1 indicates pure water, whereas zero indicates total absence of water.

The water activity of a pre-mix comprising cationic cellulosic polymer and water will be different from that of a pre-mix comprising polymer, water and solvent. When a pre-mix is provided comprising polymer, water and solvent, then preferably the water activity of the pre-mix is from 0.2 to 0.7, more preferably from 0.3 to 0.7.

Water activity values pertaining to the invention and mentioned herein are measured at a temperature of 20° C. unless otherwise stated, and are easily measured by numerous water activity measuring devices, an example of which is the HygroPalm AW obtainable from Rototronic AG of Switzerland.

Optional Heating of Pre-Mix

The process of the invention requires that a pre-mix is provided comprising cationic cellulosic polymer, water and optional solvent. The cationic cellulosic polymer is present in the pre-mix in a dissolved state as hereinbefore defined. To facilitate formation of the pre-mix comprising the cationic cellulosic polymer in a dissolved state, the components of the pre-mix can be added together and the resulting mixture heated to a temperature of up to 70° C. Preferably the temperature is from 25° C. to 60° C., more preferably the temperature is from 35° C. to 55° C.

Alternatively, the water, solvent or water and solvent mixture can be heated before addition of the cationic cellulosic polymer to facilitate incorporation of the polymer in a final dissolved form up to the temperature ranges recited above. The resulting temperature of the provided pre-mix is up to 70° C.

Surfactants

These may be in liquid form or as solid dissolved or dispersed in the substantially non-aqueous liquid composition.

Anionic Surfactant

The anionic surfactant of step b) of the aforementioned process of the invention is added to the pre-mix comprising cationic cellulosic polymer, water and optionally solvent of step a) of the process. If the pre-mix itself, or any components that make up the pre-mix have been heated to facilitate dissolution of the cationic cellulosic polymer, then preferably the anionic surfactant is added when the pre-mix is at room temperature. The anionic surfactant according to the present invention can be a single anionic surfactant or a mixture of anionic surfactants. The addition of anionic surfactant to the pre-mix at room temperature can become important when the anionic surfactant is produced ‘in-situ’ by addition of acid and base as two components to the pre-mix. This is because this neutralisation reaction will generally be exothermic, producing heat, which may need to be controlled.

The process of the invention requires at least one anionic surfactant to be added to the cationic cellulosic polymer pre-mix before addition of non-ionic surfactant. It is possible to add one such anionic surfactant to the pre-mix and add another anionic surfactant later on in the process. It is also possible to add the anionic surfactant in two or more portions at different times as long at least one anionic surfactant is added to the cationic cellulosic polymer pre-mix before addition of non-ionic surfactant.

The anionic surfactant can be added pre-formed to the cationic cellulosic polymer pre-mix, or be made in-situ. By in-situ, it is meant that one component of the anionic surfactant is added first, then the second component is added, with the added components then forming the anionic surfactant by reacting together. When the anionic surfactant is made in-situ, preferably the counter-cationic species (the neutralising species for the anionic species) is added to the pre-mix before the anionic component is added. Preferably the neutralising species is organic in nature. An illustrative example is to add the acid form of an anionic surfactant (LAS acid) and neutralise in-situ with a base. In this case, it is preferable to add the base (the counter-cationic species) to the pre-mix first, and then add the acid form of the anionic surfactant.

Preferred anionic surfactants are the linear alkyl benzene sulfonate (LAS) materials. Such surfactants and their preparation are described for example in U.S. Pat. Nos. 2,220,099 and 2,477,383, incorporated herein by reference. Particularly preferred are the sodium, potassium and mono-, di- or tri-ethanolammonium linear straight chain alkylbenzene sulfonates in which the average number of carbon atoms in the alkyl group is from about 11 to 14, with the mono-, di- or tri-ethanolammonium salts being especially preferred.

Monoethanol ammonium salt of C11-C14, e.g., C12, LAS is especially preferred. Preferred anionic surfactants include the alkyl sulfate surfactants hereof being water soluble salts or acids of the formula ROSO₃M wherein R preferably is a C10-C24 hydrocarbyl, preferably an alkyl or hydroxyalkyl having a C10-C18 alkyl component, more preferably a C12-C15 alkyl or hydroxyalkyl, and M is H or a cation, e.g., an alkali metal cation (e.g. sodium, potassium, lithium), or ammonium or substituted ammonium, especially mono-, di-, or tri-ethanolammonium.

Preferred anionic surfactants include alkyl alkoxylated sulfate surfactants hereof being water soluble salts or acids of the formula RO(A)mSO₃M wherein R is an unsubstituted C10-C24 alkyl or hydroxyalkyl group having a C10-C24 alkyl component, preferably a C12-C18 alkyl or hydroxyalkyl, more preferably C12-C15 alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation such as mono-, di- or tri-ethanolammonium.

Alkyl ethoxylated sulfates as well as alkyl propoxylated sulfates are contemplated herein. Specific examples of substituted ammonium cations include quaternary ammonium cations such as tetra methyl-ammonium and dimethyl piperdinium cations. Exemplary surfactants are C12-C15 alkyl polyethoxylate (1.0) sulfate (C12-C15E(1.0)M), C12-C15 alkyl polyethoxylate (2.25) sulfate (C12-C15E(2.25)M), C12-C1-C15 alkyl polyethoxylate (3.0) sulfate (C12-C15E(3.0)M), and C12-C15 alkyl polyethoxylate (4.0) sulfate (C12-C15E(4.0)M), wherein M is conveniently selected from sodium, potassium and mono- di- or tri-ethanolammonium.

One preferred class of anionic surfactants comprises alkylbenzenes sulfonic acids or the alkali salts thereof whereby the alkylbenzenes are alkylated using HF as the alkylation catalyst.

Other suitable anionic surfactants to be used are alkyl ester sulfonate surfactants including linear esters of C8-C20 carboxylic acids (i.e., fatty acids) which are sulfonated with gaseous SO3 according to “The Journal of the American Oil Chemists Society”, 52 (1975), pp. 323-329. Suitable starting materials would include natural fatty substances as derived from tallow, palm oil, etc.

The preferred alkyl ester sulfonate surfactant, comprise alkyl ester sulfonate surfactants of the structural formula:

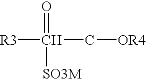

wherein R3 is a C8-C20 hydrocarbyl, preferably an alkyl, or combination thereof, R4 is a C1-C6 hydrocarbyl, preferably an alkyl, or combination thereof, and M is a cation which forms a water soluble salt with the alkyl ester sulfonate. Suitable salt-forming cations include metals such as sodium, potassium, and lithium, and substituted or unsubstituted ammonium cations such as mono-, di-, or tri-ethanolammonium. Preferably, R3 is C10-C16 alkyl, and R4 is methyl, ethyl or isopropyl.

Especially preferred are the methyl ester sulfonates wherein R3 is C10- C16 alkyl.

Other anionic surfactants useful for detersive purposes may also be included in the laundry detergent compositions of the present invention.

These may include salts, for example, sodium, potassium, ammonium, and substituted ammonium salts (such as mono-, di- and triethanolamine salts) of soap, C9-C20 linear alkylbenzenesulfonates, C8- C22 primary of secondary alkanesulfonates, C8-C24 olefinsulfonates, sulfonated polycarboxylic acids prepared by sulfonation of the pyrolyzed product of alkaline earth metal citrates, e.g., as described in British patent specification No. 1,082,179, C8-C24 alkylpolyglycolethersulfates (containing up to 10 moles of ethylene oxide); alkyl glycerol sulfonates, fatty acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinates (especially saturated and unsaturated C12-C18 monoesters) and diesters of sulfosuccinates (especially saturated and unsaturated C6-C12 diesters), sulfates of alkylpolysaccharides such as the sulfates of alkylpolyglucoside (the non-ionic nonsulfated compounds being described below), and alkyl polyethoxy carboxylates such as those of the formula RO(CH2CH20)k-CH2COO—M+ wherein R is a C8-C22 alkyl, k is an integer from 1 to 10, and M is a soluble salt-forming cation. Resin acids and hydrogenated resin acids are also suitable, such as rosin, hydrogenated rosin, and resin adds and hydrogenated resin acids present in or derived from tall oil.

Further examples are described in “Surface Active Agents and Detergents” (Vol. I and 11 by Schwartz, Perry and Berch). A variety of such surfactants are also generally disclosed in U.S. Pat. No. 3,929,678, issued Dec. 30, 1975 to Laughn, et al. at Column 23, line 58 through Column 29, line 23.

When included therein, the liquid compositions of the present invention typically comprise from about 1% to about 40%, preferably from about 10% to about 25% by weight of such anionic surfactants.

When present, the anionic surfactants may be incorporated in free acid and/or neutralised form.

Fatty Acids

The liquid composition of the invention may also comprise fatty acids as anionic surfactant component. Examples of fatty adds suitable for use in the present invention include pure or hardened fatty acids derived from palmitoleic, safflower, sunflower, soybean, oleic, linoleic, linolenic, ricinoleic, rapeseed oil or mixtures thereof. Mixtures of saturated and unsaturated fatty acids can also be used herein.

It will be recognised that the fatty acid will be present in the liquid detergent composition primarily in the form of a soap. Suitable cations include, sodium, potassium, ammonium, monoethanol ammonium, diethanol ammonium, triethanol ammonium, tetraalkyl ammonium, e.g., tetra methyl ammonium up to tetradecyl ammonium etc. cations.

The amount of fatty acid will vary depending on the particular characteristics desired in the final liquid composition of the invention.

When present, the level of the fatty acid mixture is suitably from 0.1% to 30%, preferably from 0.5% to 25%, more preferably from 10-20% by weight of the detergent composition.

Preferably the total percentage by weight of anionic surfactant or anionic surfactant mixture is from 2 to 70% by weight of the total composition.

Non-Ionic Surfactant

The non-ionic surfactant is added in step c) of the process according to the invention in a subsequent step after step b), which is the admixture of the cationic polymer pre-mix with at least one anionic surfactant. The non-ionic surfactant can be added at any time after step b) of the process of the invention. It can be added straight after the anionic surfactant or at a later stage after other additional ingredients. The non-ionic surfactant according to the present invention can be a single non-ionic surfactant or a mixture of such surfactants. Non-ionic detergent surfactants are well-known in the art. They normally consist of a water-solubilizing polyalkoxylene or a mono- or di-alkanolamide group in chemical combination with an organic hydrophobic group derived, for example, from alkylphenols in which the alkyl group contains from about 6 to about 12 carbon atoms, dialkylphenols in which primary, secondary or tertiary aliphatic alcohols (or alkyl-capped derivatives thereof), preferably having from 8 to 20 carbon atoms, monocarboxylic acids having from 10 to about 24 carbon atoms in the alkyl group and polyoxypropylene. Also common are fatty acid mono- and di-alkanolamides in which the alkyl group of the fatty acid radical contains from 10 to about 20 carbon atoms and the alkyloyl group having from 1 to 3 carbon atoms. In any of the mono- and di-alkanolamide derivatives, optionally, there may be a polyoxyalkylene moiety joining the latter groups and the hydrophobic part of the molecule. In all polyalkoxylene containing surfactants, the polyalkoxylene moiety preferably consists of from 2 to 20 groups of ethylene oxide or of ethylene oxide and propylene oxide groups. Amongst the latter class, particularly preferred are those described in European specification EP-A-225,654. Also preferred are those ethoxylated nonionics which are the condensation products of fatty alcohols with from 9 to 15 carbon atoms condensed with from 3 to 11 moles of ethylene oxide. Examples of these are the condensation products of C₁₁₋₁₃ alcohols with (say) 3 or 7 moles of ethylene oxide. These may be used as the sole non-ionic surfactants or in combination with those of the described in the last-mentioned European specification. These non-ionics may also be used as solvent material.

Preferably, the non-ionic surfactant is selected from the group consisting of fatty alcohol ethoxylates, alkylphenol ethoxylates, ethylene oxide/propylene oxide block polymers and mixtures thereof.

Preferably the non-ionic surfactant or mixture thereof is present in the composition at a level of from 2 to 50% by weight of the total composition.

Ratio of Non-Ionic to Total Surfactant Levels

Due to the variety of the possible percentages of surfactants present in fabric treatment detergents, it is understood that the skilled person can adjust the level of surfactants to meet the desired need in each individual case. This is especially true in cases where a certain viscosity of the detergent is needed. However, according to the process of the present invention, the non-ionic surfactant is present at a level of 5% or higher, by weight of total surfactant present in the composition, preferably the level of non-ionic surfactant is up to 80% of the total surfactant present by weight. “By weight of total surfactant” is herein given the definition of the weight of the total amount of anionic surfactant+total weight of non-ionic surfactant. When the anionic surfactant is produced in-situ, the ‘total surfactant’ would be the acid component of the anionic surfactant+base component of anionic surfactant+non-ionic surfactant

Viscosity of the Products

The viscosity of the products was measured on a Bohlin rheometer with cone-plate 4°/40 geometry at 25° C., at a shear rate of 21 s⁻¹. As stated earlier, formulations that are highly viscous can pose a problem when it comes to the filling of the final product. For this reason, products which can exhibit a lower viscosity are preferred. A preferred viscosity for formulation products is 600 mPa·s measured at 25° C. 21 1/s.

Products made according to this invention exhibit improved stability, defined herein as exhibiting no sign of phase separation or precipitate formation after 1 week when stored at room temperature.

Further provided by the present invention is a unit dose fabric treatment product comprising a non-aqueous liquid fabric treatment composition obtainable by the process outlined in the application.

This product exhibits improved stability. A product is considered to exhibit improved stability as defined herein when after 1 week at room temperature it exhibits no signs of phase separation or precipitate formation.

Optional Ingredients

The non-aqueous liquid fabric treatment comprised in the unit dose capsule/sachet can optionally further comprise one or more ingredients selected from builders, (additional polymers), fluorescers, enzymes, silicone foam control agents, perfumes, dyes, bleaches and preservatives. Some of these materials will be solids which are insoluble in the substantially non-aqueous liquid medium. In that case, they will be dispersed in the substantially non-aqueous liquid medium and may be deflocculated by means of one or more acidic components such as selected from inorganic acids, anionic surfactant acid precursors and Lewis acids, as disclosed in EP-A-266,199.

While it is not necessary for these elements to be present in order to practice the invention, the use of such materials is often very helpful in rendering the formulation acceptable for consumer use.

Liquid Unit Dose

A liquid unit dose fabric treatment composition is made up of a packaging material which encapsulates a set dose of liquid cleaning composition. The amount of this liquid cleaning composition in the package, i.e. the unit dose volume, may for example be from 10 ml to 100 ml, e.g. from 12.5 ml to 75 ml, preferably from 15 ml to 60 ml, more preferably from 20 ml to 55 ml. The substantially non-aqueous liquid composition effectively provides a cleaning function when released into the wash liquor. The unit dose liquid fabric treatment composition can take various product forms, for example a capsule or sachet.

Liquid Unit Dose—Packaging Materials

The packaging material of the unit dose composition should fulfil the role of a stable encapsulation material to keep the integrity of the product whole, while also being a material which will dissolve or otherwise dispense the cleaning composition contained within at temperatures associated with laundry conditions. For the purposes of the present invention, which concerns a non-aqueous liquid fabric treatment composition, the encapsulating material can be a water soluble package formed from a water soluble film.

The water soluble film effectively comprises a water soluble polymer. As used herein, the term “water soluble polymer” refers to a polymer that dissolves and/or dispenses completely in water within 30 minutes with agitation, e.g. by means of hand, stick or other stirrer or under the action of a mechanical washing machine and at a relevant temperature. A “relevant temperature” is one at which the consumer will need to dissolve or disperse the polymer component at the beginning of, or during a cleaning process. A polymer is to be regarded as dissolving or dispersing at a “relevant temperature” if it does so under the aforementioned conditions at a temperature anywhere in the range of from 20° C. to 60° C.

Preferred water soluble polymers are those capable of being cast into a film or solid mass and may for example as described in Davidson and Sittig, Water-Soluble Resins, Van Nostrand Reinhold Company, New York (1968). The water-soluble polymer should have such characteristics, such as strength and heat-sealability, to permit machine handling during the processes of making the water soluble package. Preferred water-soluble resins include polyvinyl alcohol and copolymers thereof, cellulose ethers, polyethylene oxide, polyvinylpyrrolidone, polymaleic anhydride and copolymers thereof, hydroxyethylcellulose, methylcellulose, acrylamide and copolymers thereof, polyethyleneimine, ethyl hydroxyethylcellulose, ethyl methylcellulose, hydroxyethyl methylcellulose. In this context, it is noted that co-polymers can be made of 2 or more types of monomers.

Water-soluble, polyvinyl alcohol film-forming resins are most preferred for use in the packaging material of the unit dose fabric treatment product.

Polyvinyl alcohols (PVA) preferred for use herein have an average molecular weight anywhere between 1,000 and 100,000, preferably between 5,000 and 250,000, for example between 15,000 and 150,000. Hydrolysis, or alcoholysis, is defined as the percent completion of the reaction where acetate groups on the resin are substituted with hydroxyl, —OH, groups. A hydrolysis range of from 60-99% of polyvinyl alcohol film-forming resin is preferred, while a more preferred range of hydrolysis is from about 70-90% for water-soluble, polyvinyl alcohol film-forming resins. The most preferred range of hydrolysis is 80-89%. As used in this application, the term “polyvinyl alcohol” includes polyvinyl acetate compounds with levels of hydrolysis disclosed herein. The water-soluble resin film should be formulated so as to substantially completely dissolve in 50° C. water with agitation within about thirty minutes, preferably within about 15 minutes in 50° C. water with agitation, and most preferably within about 5 minutes in 50° C. water with agitation.

Suitable PVA films for use in a package according to the invention are commercially available and described, for example, in EP-B-291,198. PVA films for use in a package according to the invention can be made by the copolymerisation of vinyl acetate and a carboxylate-containing monomer (for example acrylic, maleic or itaconic acid or acid ester), followed by partial (for example up to about 90%) hydrolysis with sodium hydroxide.

Suitable water soluble films can also be made from blends of two or more polymers/copolymers as mentioned above, and having different compositions or molecular weights.

The water soluble film may further comprise the following minor ingredients: anti-blocking agents, such as silica, fillers (e.g. starch and talc), colourants, release agents and surfactants.

Generally speaking, the water soluble film of the invention incorporates a plasticizer system containing one or more plasticizers. Plasticizers suitable for use with PVA-based films have —OH groups in common with the —CH2—CH(OH)—CH2-CH(OH)-polymer chain of the film polymer. Their mode of functionality is to introduce short chain hydrogen bonding with the chain hydroxyl groups and thus weaken adjacent chain interactions which inhibits swelling of the aggregate polymer mass—the first stage of film dissolution.

Water itself is a suitable plasticizer for any of the films recited herein. Other suitable plasticizers are selected from the group consisting of pentane diols, butane diols, propane diols, glycerol, trimethylolpropane, sorbitol, diethylene glycol, triethylene glycol, and dipropylene glycol. The plasticizer system may suitably include a plasticizer material which is the same chemical compound as any solvent in the liquid composition. Furthermore, said plasticizer material may be effectively the main plasticizer in the film.

The total amount of plasticizer in the film (i.e. per unit weight of film) may vary considerably according to the film type and plasticizer type. It could for example be in the range of from 0.1% to 50%, e.g. 10% to 45%, such as 20% to 40% by weight. In PVA-based films which are preferably used in the present invention, the plasticizer system is desirably present in a total amount of above 10% by weight.

Encapsulation Methods

(a) Horizontal Form-Fill-Seal

Water soluble films based on PVA can be made according to any of the horizontal form-fill-seal methods described in any of WO-A-00/55044, WO-A-00/55045, WO-A-00/55046, WO-A-00/55068, WO-A-00/55069 and WO-A-00/55415. During the forming, filling and sealing steps of this process, it may be desirable to maintain the relative humidity at a reasonable level. This is done to maintain the heat sealing characteristics of the film. When handling thinner films, it may be necessary to reduce the relative humidity to ensure that the films have a relatively low degree of plasticisation and are therefore stiffer and easier to handle.

(b) Vertical Form-Fill-Seal

In the vertical form-fill-seal (VFFS) technique, a continuous tube of flexible plastics film is extruded. It is sealed, preferably by heat or ultrasonic sealing, at the bottom, filled with the liquid composition, sealed again above the liquid film and then removed from the continuous tube, e.g. by cutting.

(c) Rotary Form-Fill-Seal

Alternatively, a rotary form-fill-seal technique may be used. In this technique, forming, filling and sealing of water soluble packages is carried out using a rotary drum that has forming cavities or recesses on its curved surface.

Instead of heat sealing as described above, solvent sealing, ultrasonic sealing or any other type of sealing known in the art could be applied for producing the package of the present invention. When solvent sealing is used and the film contains PVA, an aqueous solution or water are preferably used as a solvent.

### Examples

The invention will now be illustrated by the following non-limiting examples. Comparative Examples are designated by letters, while Examples of the invention are designated by numbers. The ingredients were added in the order stated in the table, unless otherwise stated. The weights in the table are stated as weight percentages based on the total composition, out of a total of 100 wt. % for the total formulation. A list of ingredients used with the sources, along with explanations of acronyms used in the tables is stated below:
Cationic cellulosic polymer:—UCARE polymer LR-400 Dow
Solvents:—MonoPropyleneGlycol Industrial (MPG) (1,2-propanediol) of Vos B.V; and Glycerine S.G.1.26 (Glycerol) (1,2,3-propanetriol) Chemproha Chemiepartner
Anionic surfactants:—Linear AlkylbenzylSulphonate (LAS)—In house production.
   Active matter 97.1%; and
   Prifac 5908 of Uniqema GMBH & Co KG
Non-ionic surfactant:—Neodol 25-7E of Shell Chemicals UK Ltd
Optional ingredients:—(MEA) Monoethanalamine pure (2-aminoethanol) of BASF
Minors:—(Sequestrant) Dequest 2046 31% aqueous solution of Solutia Europe SA/NV

Ingredients added under the heading “minors” generally relate to other optional ingredients such as perfume and sequestrant.

Stability

A formulation shall be considered ‘stable’ when after 1 week at room temperature it exhibits no signs of phase separation or precipitate formation.

### Comparative Examples

### Example A

### Preparation of Non-Aqueous Detergent Formulation Without any Cationic Cellulosic Softness Polymer

To make this formulation the ingredients were added in the order stated in the table. The formulation was made in a beaker. The contents of the beaker were mixed using an overhead stirrer. A ice/hot water bath was used to control temperature of the contents of the beaker because the anionic surfactant was made ‘in-situ’ and the neutralisation reaction produces heat. In this case the base (MEA) was added first, this is the counter-cationic species of the anionic surfactant. The total amount of LAS acid was added in two portions in order to control the temperature between the 30° C. and the 45° C. during preparation of the anionic surfactant. The minor components were added under ambient conditions.

TABLE 1
Comparative formulation A without any cationic
cellulosic softness polymer

| | Formulation |
|---|---|
| | Formulation A |
| Surfactant mix | |
| Neodol 25-7E | 20.2% |
| MPG | 20.2% |
| Glycerine 1,26 | 2.9% |
| Monoethanolamine | 9.7% |
| LAS ACID (as recvd.) | 6.9% |
| Prifac 5908 | 17.2% |
| LAS ACID (as recvd.) | 13.8% |
| Minors | |
| Sequestrant Dequest 2046 | 3.2% |
| (as recvd.) | |
| Other Minors incl. | 2.9% |
| Perfume | |
| Water | 2.9% |
| Total | 100% |
| Stability | Stable |

### Example B

### Preparation of Non-Aqueous Detergent Formulation with a Cationic Cellulosic Softness Polymer by Simple Addition of the Polymer

For comparative purposes, two formulations were attempted wherein the cationic cellulosic polymer was incorporated at two different stages in making the non-aqueous formulation. For example Bi, the LR-400 polymer powder (the cationic cellulosic polymer) was added after the whole formulation was made and for example B2, the polymer was added after the surfactant mix was made, i.e., before the minors were added. Neither formulation proved stable and a polymer precipitate was obtained overnight at the bottom.

TABLE 2
Comparative formulations B1 and B2 the cationic
cellulosic softness polymer by simple addition of the
polymer varying the point of addition of the polymer.

Formulation

| | Formulation B1 | Formulation B2 |
|---|---|---|
| Surfactant mix | | |
| Neodol 25-7E | 20.2% | 20.2% |
| MPG | 19.7% | 19.7% |
| Glycerine 1,26 | 2.9% | 2.9% |
| Monoethanolamine | 9.7% | 9.7% |
| LAS ACID (as recvd.) | 6.9% | 6.9% |
| Prifac 5908 | 17.2% | 17.2% |
| LAS ACID (as recvd.) | 13.8% | 13.8% |
| LR-400 polymer | — | 0.5% |
| Minors | | |
| Sequestrant Dequest 2046 | 3.2% | 3.2% |
| (as recvd.) | | |
| Other Minors incl. Perfume | 2.9% | 2.9% |
| Water | Rest | Rest |
| LR-400 polymer | 0.5% | — |
| Total | 100% | 100% |
| Stability | Unstable | Unstable |

### Example C

### Preparation of Non-Aqueous Detergent Formulation with a Cationic Cellulosic Softness Polymer using the Prior-Art Route as Disclosed in WO-A-2004/056958 at pg. 38

In this route, quoted in the above reference at pg. 38 as a preferred way to make fabric treatment compositions, a pre-mix of cationic polymer was made in MPG-water solution with the following composition, this can be thought of as a fabric softening system with the following ratio of ingredients:

| | |
|---|---|
| Polymer | 4.1% |
| Water | 25.6% |
| MPG | 70.3% |

This pre-mix (fabric softening system) was added to the formulation as in example A (a typical fabric cleaning system) except that only half the MPG was added in the surfactant mix—the other half came with the pre-mix to give the same composition as in Example B. The ratio of pre-mix to the rest of the formulation was 11.5:88.5. This formulation had a slimy appearance and also proved unstable after some time because the polymer precipitated.

TABLE 3
Preparation of comparative example C by the
process described in prior art WO-A-2004/056958

| | Formulation |
|---|---|
| | Formulation C |
| LR 400 Polymer pre-mix | |
| MPG | 8.1% |
| Water | 2.9% |
| Polymer | 0.5% |
| Surfactant mix | |
| Neodol 25-7E | 20.2% |
| MPG | 10.1% |
| Glycerine 1,26 | 2.9% |
| Monoethanolamine | 9.7% |
| LAS ACID (as recvd.) | 6.9% |
| Prifac 5908 | 17.2% |
| LAS ACID (as recvd.) | 13.8% |
| Minors | |
| Sequestrant Dequest 2046 | 3.2% |
| (as recvd.) | |
| Other Minors incl. | 2.9% |
| Perfume | |
| Total | 100% |
| Stability | Unstable |

### Examples According to the Invention

### Example 1

### Preparation of Non-Aqueous Detergent Formulation with a Cationic Cellulosic Softness Polymer Using the Invented Route

Example 1A is an embodiment according to the invention, while 1B is another example for comparative purposes wherein the order of addition of the anionic surfactant and the non-ionic surfactant was changed.

Both formulations of this example were made by dissolving the polymer into the MPG and the water to form a pre-mix, the water activity of the pre-mix was measured to be 0.33 measured at 20° C. on a HygroPalm AW obtainable from Rototronic AG of Switzerland as stated earlier.

The percentage composition of the pre-mix was:

| | |
|---|---|
| MPG | 85.3% |
| LR-400 polymer: | 2.0% |
| Water | 12.7%. |

The inclusion level of the MPG, Polymer and water pre-mix would be 23.1% of the total weight of the formulation, but it is also possible to make the formulation in situ. In this example, the pre-mix was heated to a temperature of 45° C. The following two orders of addition was used, with the ingredients of ingredients done sequentially according to table 4. The anionic surfactants were added first in formulation 1A, while for comparative purposes in formulation 1B, the non-ionic surfactant was added first. This second formulation was discontinued during the process as a polymer precipitate had already formed. The formulation details for this example are stated in table 4.

TABLE 4
Preparation of stable formulation 1A according to
the invention and formulation 1B done for comparative
purposes.

Formulation

| | Formulation | Formulation |
|---|---|---|
| | 1A | 1B |
| Polymer pre-mix | | |
| MPG | 19.70 | 19.70 |
| LR 400 Polymer | 0.5 | 0.5 |
| Water | 2.9 | 2.9 |
| Glycerine 1,26 | 2.9% | |
| Surfactants | | |
| Neodol 25-7E | — | 20.2% |
| Monoethanolamine | 9.7% | Not added |
| | | (polymer |
| | | precipitate |
| | | obtained) |
| LAS ACID (as recvd.) | 6.9% | |
| Prifac 5908 | 17.2% | |
| LAS ACID (as recvd.) | 13.8% | |
| Neodol 25-7E | 20.2% | |
| Minors | | |
| Sequestrant Dequest 2046 | 3.2% | |
| (as recvd.) | | |
| Other Minors incl. | 2.9% | |
| Perfume | | |
| Total | 100% | — |
| Stability | Stable | Unstable |

Formulation 1A proved stable according to the stability test stated earlier.

### Example 2

### Preparation of Non-Aqueous Detergent Formulation with the Cationic Cellulosic Softness Polymer Using the Invented Process with Different Levels of Non-Ionic Surfactant

TABLE 4
Formulations 2A-D detailing the effect on
stability and viscosity of the level of non-ionic surfactant
as a weight percentage of the total surfactant

| | Formulation | | | |
|---|---|---|---|---|
| | | | 2C (equal | |
| | 2A | 2B | to 1A) | 2D |
| Polymer pre-mix | | | | |
| MPG | 19.70% | 19.70% | 19.70% | 19.70% |
| LR-400 | 0.5% | 0.5% | 0.5% | 0.5% |
| Water | 2.9% | 2.9% | 2.9% | 2.9% |
| Glycerine 1,26 | 2.9% | 2.9% | 2.9% | 2.9% |
| Surfactants | | | | |
| Monoethanolamine | 2.1% | 4.0% | 9.7% | 11.3% |
| LAS ACID type 1L (as | 9.9% | 19.2% | 6.9% | 53.8% |
| recvd.) | | | | |
| Prifac 5908 | — | — | 17.2% | — |
| LAS ACID type 1L (as | — | — | 13.8% | — |
| recvd.) | | | | |
| Neodol 25-7E | 55.9% | 44.7% | 20.2% | 2.8% |
| Minors | | | | |
| Dequest 2046 (as recvd) | 3.2% | 3.2% | 3.2% | 3.2% |
| Other Minors incl. | 2.9% | 2.9% | 2.9% | 2.9% |
| Perfume | | | | |
| Total | 100% | 100% | 100% | 100% |
| % of non-ionic surfactant | 85% | 70% | 35% | 3.2% |
| present by weight of | | | | |
| total surfactant | | | | |
| Stability | No | Yes | Yes | Yes |
| Viscosity mPa · s at | — | 263 | 511 | 1630 |
| 25° C. 21 1/s | | | | |

It is noted that formulations 2B and 2C have a good viscosity level for ease of product filling.

1. A process for the preparation of a non-aqueous liquid fabric treatment composition comprising no more than 20% by weight of water, characterised in that the process comprises:
a) provision of a pre-mix comprising cationic cellulosic polymer, water and optional solvent;
b) admixture of the pre-mix with at least one anionic surfactant; and
c) subsequent addition of non-ionic surfactant;
wherein the steps a) to c) are performed sequentially.

2. A process for the preparation of a unit dose fabric treatment product comprising a non-aqueous liquid fabric treatment composition comprising no more than 20% by weight of water, characterised in that the process comprises:
a) provision of a pre-mix comprising cationic cellulosic polymer, water and optional solvent;
b) admixture of the pre-mix with at least one anionic surfactant;
c) subsequent addition of non-ionic surfactant,
wherein the steps a) to c) are performed sequentially, and wherein the process further comprises encapsulation of the non aqueous fabric treatment composition into a unit dose package.

3. A process according to claim 1, wherein the cationic cellulosic polymer is a quaternary ammonium salt of a hydroxyethyl or hydroxypropyl substituted cellulosic polymer.

4. A process according to claim 3, wherein the cationic cellulosic polymer is selected from the group comprising cocodimethylammonium hydroxypropyl oxyethyl cellulose, lauryldimethylammonium hydroxypropyl oxyethyl cellulose, stearyldimethylammonium hydroxypropyl oxyethyl cellulose, and stearyldimethylammonium hydroxyethyl cellulose; cellulose 2-hydroxyethyl 2-hydroxy 3-(trimethyl ammonio)propyl ether salt, polyquaternium-4, polyquaternium-10, polyquaternium-24 and polyquaternium-67 or mixtures thereof.

5. A process according to claim 1, wherein the cationic cellulosic polymer is polyquaternium-10.

6. A process according to claim 1, wherein the cationic cellulosic polymer has a molecular weight of less than about 850,000 Daltons.

7. A process according to claim 1, wherein when the polymer pre-mix of step a) is made by dissolving the cationic polymer in a water and solvent mixture, the water activity of the pre-mix is from 0.2 to 0.7.

8. A process according to claim 7, wherein the water activity of the pre-mix is from 0.3 to 0.7.

9. A process according to claim 1, wherein the anionic surfactant has an organic counterion chosen from mono-, di- or tri-ethanolammonium salts.

10. A process according to claim 1, wherein the anionic surfactant is present in the composition at a level of from 2 to 70% by weight of the total composition.

11. A process according to claim 1, wherein the non-ionic surfactant is selected from the group consisting of fatty alcohol ethoxylates, alkylphenol ethoxylates, ethylene oxide/propylene oxide block polymers and mixtures thereof.

12. A process according to claim 1, wherein the non-ionic surfactant is present in the composition at a level of from 2 to 50% by weight of the total composition.

13. A process according to claim 1, wherein the non-ionic surfactant is present at a level of from 5 to 80% by weight of total surfactant present in the composition.

14. A process according to claim 1, wherein the solvent is selected from the group consisting of 1,3-propanediol and 2-methyl-1,3-propanediol, glycerine, ethylene glycol, trimethylene glycol, tetramethylene glycol, pentamethylene glycol, propylene glycol, diethylene glycol, 2,3 butanediol, 1,4-butanediol, and 1,3-butanediol, and mixtures thereof.

15. A process according to claim 1, wherein the solvent is present at a level of from 2.5 to 50% by weight of the total composition.

16. A liquid fabric treatment product obtainable by the process according to claim 1.

17. A liquid unit dose fabric treatment product obtainable by the process according to claim 2.

18. A composition according to claim 16, wherein the viscosity of the composition is from 100 to 600mPa·s at 25° C. 21 1/s.

19. A method of fabric treatment comprising the steps of:
a) providing a unit dose fabric treatment product comprising a non-aqueous liquid fabric treatment composition according to claim 16; and,
b) contacting one or more articles with the composition at one or more points during a laundering process.

20. A method according to claim 18 wherein step b) occurs during the main wash of a laundering process.

21. Use of a liquid unit dose fabric treatment product according to claim 16 to soften fabric.
